(19) United States
(12) Patent Application Publication
(10) Pub. No.: US 2021/0092787 A1
(43) Pub. Date: Mar. 25, 2021

(54) Signaling for Improving Multicarrier Utilization

(71) Applicant: Telefonaktiebolaget LM Ericsson (publ), Stockholm (SE)

(72) Inventors: Mattias Bergström, Sollentuna (SE); Håkan Palm, Växjö (SE)

(21) Appl. No.: 16/630,767

(22) PCT Filed: Jul. 25, 2018
(86) PCT No.: PCT/SE2018/050775

§ 371 Date: Jan. 13, 2020

Related U.S. Application Data
(60) Provisional application No. 62/543,678, filed on Aug. 10, 2017.

(51) Int. Cl. H04W 76/15; H04L 5/00; H04W 24/10; H04W 72/08

(52) U.S. Cl. CPC H04W 76/15; H04L 5/001; H04W 76/28; H04W 24/10; H04W 72/085; H04L 5/0098

(57) ABSTRACT

In one aspect, a wireless device (50) configured for multi-carrier operation in a wireless communication network performs (702) measurements on one or more cells and/or beams and/or carriers, while in idle mode or in an inactive state. The wireless device determines (704) information for assisting an establishment of multi-carrier operation, based on the measurements, and transmits (706) the information to the wireless communication network. A network node receives this information for the cells/PERFORM beams/carriers and selects, based on the received information, one or more cells/beams/carriers for multi-carrier operation with the wireless device. The network node establishes multi-carrier operation for the wireless device using the selected cells/beams/or carriers.

### TECHNICAL FIELD

The present disclosure is generally related to wireless communications networks and is more particularly related to a wireless device configured for multi-carrier operation in a wireless communication network and network nodes configured to assist the wireless device with the multi-carrier operation.

### BACKGROUND

In the advanced wireless networks developed by the 3^{rd}-Generation Partnership Project (3GPP), multi-carrier (or multi-cell) operations can be used to increase per-user throughput for user equipments (UEs) having good channel conditions and having the capability to receive and transmit at higher data rates. Carrier aggregation (CA) is one type of multi-carrier operation, where the UE is able to receive/transmit data or higher layer signaling with more than one serving cell. The carrier of each serving cell is generally called a component carrier (CC). One of the CCs may be designated as the primary component carrier (PCC) and the remaining CCs are designated as secondary component carriers (SCC). The serving cell on or associated to a PCC is called primary cell (PCell) or primary serving cell, whereas a serving cell on and/or associated to a SCC is called secondary cell (SCell) or secondary serving cell. At least the PCell exists in both uplink and downlink directions. When there is only a single uplink CC, the PCell must be on that CC. The CCs can be co-located in the same geographical location or site or can be non-co-located or any combination thereof. Note that the terms component carrier and cell are sometimes used interchangeably in the context of CA.

The number of aggregated CCs as well as the bandwidths of the individual CCs may be different for uplink and downlink. A symmetric configuration refers to the case where the number of CCs in downlink and uplink is the same, whereas an asymmetric configuration refers to the case that the number of CCs is different. It is important to note that the number of CCs configured in a cell may be different from the number of CCs seen by a terminal. That is, a terminal may, for example, support more downlink CCs than uplink CCs, even though the cell is configured with the same number of uplink and downlink CCs.

Dual connectivity (DC) may be seen as a special case of CA, where the CCs assigned to the UE operate from different base station sites (different eNodeBs, eNBs or gNBs). For example, a first node, which may be referred to as master eNB (MeNB), and a second node, which may be referred to as secondary eNB (SeNB). At least one serving cell of and/or associated to and/or provided by the MeNB may be, be called, and/or represent a PCell, and one serving cell of and/or associated to and/or provided by SeNB may be, be called, and/or represent a PSCell. Each of the PCell and the PSCell may provide both uplink and downlink connections and/or at least one uplink carrier and at least one downlink carrier. The serving cells operated by a MeNB belong to a master cell group (MCG), whereas serving cells operated by a SeNB belong to secondary cell group (SCG). There can be one or more secondary cells (SCell) attached to either MeNB and/or SeNB; control information for SCells may be provided on the corresponding PCell or PSCell, respectively.

In multi-carrier operation, the cells on the different cell layers may have different coverages as illustrated by FIGS. 1-5 (from 3GPP TS 36.300). In FIG. 1, F1 and F2 cells are co-located and overlaid, providing nearly the same coverage. Both layers provide sufficient coverage and mobility can be supported on both layers. The likely scenario is when F1 and F2 are of the same band, such as 2 GHz or 800 MHz. It is expected that aggregation is possible between overlaid F1 and F2 cells.

In FIG. 2, F1 and F2 cells are co-located and overlaid, but F2 has smaller coverage due to larger path loss. F1 provides more-or-less continuous coverage, while F2 is used to improve throughput. Mobility is performed based on F1 coverage. The likely scenario for this sort of arrangement is that F1 and F2 are of different bands. For example, F1={800 MHz, 2 GHz} and F2={3.5 GHz}. It is expected that aggregation is possible between overlaid F1 and F2 cells.

In FIG. 3, F1 and F2 cells are co-located, but F2 antennas are directed to the cell boundaries of F1, so that cell edge throughput is increased. F1 provides more-or-less continuous coverage, but F2 potentially has holes, such as due to larger path loss. Mobility is based on F1 coverage. The likely scenario in this sort of arrangement is that F1 and F2 are of different bands. For example, F1={800 MHz, 2 GHz} and F2={3.5 GHz}. It is expected that F1 and F2 cells of the same eNB can be aggregated where coverage overlaps.

In FIG. 4, F1 provides macro coverage, while on F2, Remote Radio Heads (RRHs) are used to improve throughput at hot spots. Mobility is performed based on F1 coverage. The likely scenarios are both when F1 and F2 are DL non-contiguous carrier on the same band, such as 1.7 GHz, and F1 and F2 are of different bands. For example, F1={800 MHz, 2 GHz} and F2={3.5 GHz}. It is expected that F2 RRHs cells can be aggregated with the underlying F1 macro cells. This is similar to the scenario in FIG. 2, but with frequency selective repeaters deployed so that coverage is extended for one of the carrier frequencies. It is expected that F1 and F2 cells of the same eNB can be aggregated where coverage overlaps.

When in idle mode, the UE is camped on a cell on a carrier (layer). When in connected mode using multi-carrier operation, such as CA or DC, the UE is in communication via one cell on each frequency layer. However, the current multi-carrier framework is not the most optimum from a delay perspective, especially for CA in the case of SCell configuration and activation. The delays reduce the efficiency of radio resource and CA usage, especially in small cell deployments. Managing a large number of small cells efficiently together with CA will become challenging as the number of deployed small cells on different carriers is expected to increase. Therefore, the current CA framework adds additional latencies, which then limits the usage of CA and reduces the offloading gains that CA could potentially provide. For instance, in the case where there are noticeable latencies in configuring and activating an SCell, it may be that the data available for transmission is already served by PCell, before SCell is activated. The DC framework has constraints similar to the CA framework, and reducing delay and signaling overhead is also important for DC.

Blind configuration of SCell could be one alternative for reducing signaling overhead and delays, but blind configurations are practically limited to co-located cells only and therefore, it cannot be used as general solution for reducing latencies for CA operations. Extending blind configurations to all deployment scenarios does not seem feasible or even helping in practice due to lack of UE cell detection and measurements prior to blindly configuring SCells. The cell detection and measurements after the blind configuration signaling introduce significant additional delay.

Challenges seen in the efficient use of E-UTRAN CA and DC equally apply to the future LTE multi-carrier use cases where, for example, DC may be utilized between Long Term Evolution (LTE) and New Radio (NR) Access Technology.

### SUMMARY

Embodiments of the present invention provide enhancements for enabling more efficient multi-carrier operation and faster multi-carrier establishment setup times. Cutting down the time needed to establish multi-carrier operation with multiple cells from an idle mode will provide for a higher bit rate sooner for a UE in LTE and NR deployments. For instance, the network will be able to decide at connection establishment that multi-carrier operation is possible for a specific UE, such as when this UE is within coverage of cells on other carriers.

In some cases, the UE will provide cell/beam/carrier measurement information to the network at connection establishment, so that the network can use this information to select cells and/or beams and/or carriers for multi-carrier operation that provide sufficient coverage to the UE. For example, according to some embodiments, a method in a wireless device configured for multi-carrier operation in a wireless communication network includes performing measurements on one or more cells and/or beams and/or carriers, while in idle mode or in an inactive state. The method also includes determining information for assisting an establishment of multi-carrier operation, based on the measurements and transmitting the information to the wireless communication network.

According to some embodiments, a method in a network node configured to assist a wireless device with multi-carrier operation in a wireless communication network includes receiving, from the wireless device, measurement information for one or more cells and/or beams and/or carriers. The method also includes selecting, based on the received measurement information, one or more cells and/or beams and/or carriers for multi-carrier operation with the wireless device. The method further includes establishing multi-carrier operation for the wireless device using the selected cells and/or beams and/or carriers.

In other cases, the UE or the network stores information on cells/beams/carriers used in earlier multi-carrier communication and then reuses this at a subsequent connection attempt. For example, according to some embodiments, a method in a wireless device configured for multi-carrier operation in a wireless communication network includes storing information for one or more cells and/or beams and/or carriers used for multi-carrier operation and determining, upon connection establishment after being in idle mode or in an inactive state, that the one or more cells and/or beams and/or carriers previously used for multi-carrier operation are available to the wireless device. The method also includes transmitting an indication that the one or more cells and/or beams and/or carriers are again available to the wireless device for multi-carrier operation.

According to some embodiments, a method in a network node configured to support multi-carrier operation in a wireless communication network includes determining, upon connection establishment with a wireless device, that the wireless device was previously connected to the network node while in multi-carrier operation. The method also includes, responsive to the determining, using stored information relating to the wireless device's previous operation with multi-carrier operation to identify one or more cells and/or beams and/or carriers for configuring the wireless device for multi-carrier operation.

According to some embodiments, a wireless device configured for multi-carrier operation in a wireless communication network includes transceiver circuitry configured for multi-carrier communication and processing circuitry operatively associated with the transceiver circuitry. The processing circuitry is configured to perform measurements on one or more cells and/or beams and/or carriers, while in idle mode or in an inactive state, and determine information for assisting an establishment of multi-carrier operation, based on the measurements. The processing circuitry is configured to transmit the information to the wireless communication network.

According to some embodiments, a network node configured to assist a wireless device with multi-carrier operation in a wireless communication network includes transceiver circuitry configured for communicating with the wireless device in multi-carrier operation and processing circuitry operatively associated with the transceiver circuitry. The processing circuitry is configured to receive, from the wireless device, measurement information for one or more cells and/or beams and/or carriers and select, based on the received measurement information, one or more cells and/or beams and/or carriers for multi-carrier operation with the wireless device. The processing circuitry is configured to establish multi-carrier operation for the wireless device using the selected cells and/or beams and/or carriers.

According to some embodiments, a wireless device configured for multi-carrier operation in a wireless communication network includes transceiver circuitry configured for multi-carrier communication and processing circuitry operatively associated with the transceiver circuitry. The processing circuitry is configured to store information for one or more cells and/or beams and/or carriers used for multi-carrier operation and determine, upon connection establishment after being in idle mode or in an inactive state, that the one or more cells and/or beams and/or carriers previously used for multi-carrier operation are available to the wireless device. The processing circuitry is configured to transmit an indication that the one or more cells and/or beams and/or carriers are again available to the wireless device for multi-carrier operation.

According to some embodiments, a network node configured to support multi-carrier operation in a wireless communication network includes transceiver circuitry configured for communicating with the wireless device in multi-carrier operation and processing circuitry operatively associated with the transceiver circuitry. The processing circuitry is configured to determine upon connection establishment with a wireless device, that the wireless device was previously connected to the network node while in multi-carrier operation. The processing circuitry is configured to, responsive to the determining, use stored information relating to the wireless device's previous operation with multi-carrier operation to identify one or more cells and/or beams and/or carriers for configuring the wireless device for multi-carrier operation.

Other embodiments include an apparatus, wireless devices, computer program products, computer readable medium and functional module implementations that carry out the methods described above.

### BRIEF DESCRIPTION OF THE FIGURES

FIG. 1 illustrates co-located and overlaid cells, providing nearly the same coverage.

FIG. 2 illustrates co-located and overlaid cells, with one cell providing smaller coverage due to larger path loss.

FIG. 3 illustrates co-located cells, with antennas of one cell directed to the cell boundaries of the other.

FIG. 4 illustrates macro coverage cells with RRUs used to improve hot spots.

FIG. 5 illustrates co-located and overlaid cells, with one cell providing smaller coverage due to larger path loss, and with frequency selective repeaters deployed to extend coverage for a carrier frequency.

FIG. 6 illustrates a block diagram of a wireless device, according to some embodiments.

FIG. 7 is a process flow diagram illustrating a method carried out in the wireless device, according to some embodiments.

FIG. 8 illustrates a block diagram of a network node, according to some embodiments.

FIG. 9 is a process flow diagram illustrating a method carried out in the network node, according to some embodiments.

FIG. 10 is a process flow diagram illustrating another method carried out in the wireless device, according to some embodiments.

FIG. 11 is a process flow diagram illustrating another method carried out in the network node, according to some embodiments.

FIG. 12 is an example functional implementation of a wireless device, according to some embodiments.

FIG. 13 is another example functional implementation of a wireless device, according to some embodiments.

FIG. 14 is an example functional implementation of a network node, according to some embodiments.

FIG. 15 is another example functional implementation of a network node, according to some embodiments.

FIG. 16 illustrates a functional implementation of a network node, according to some embodiments.

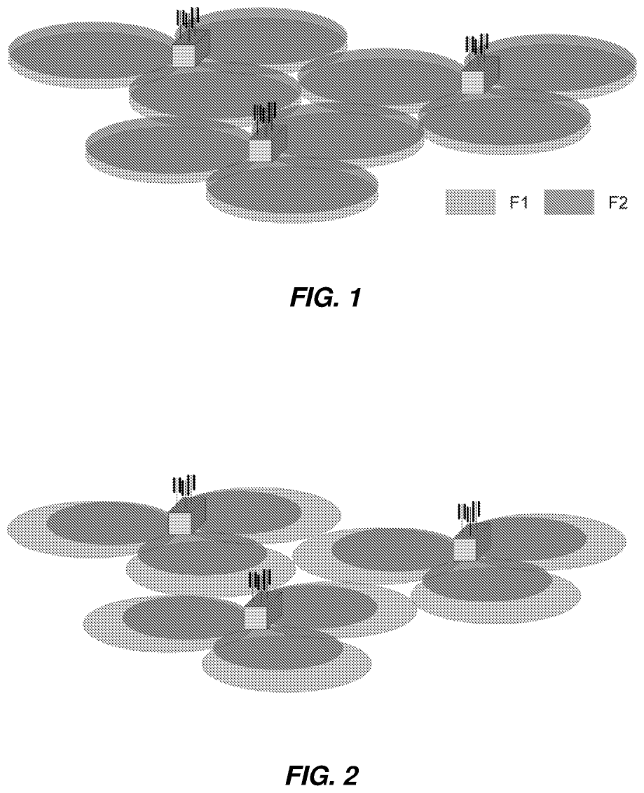

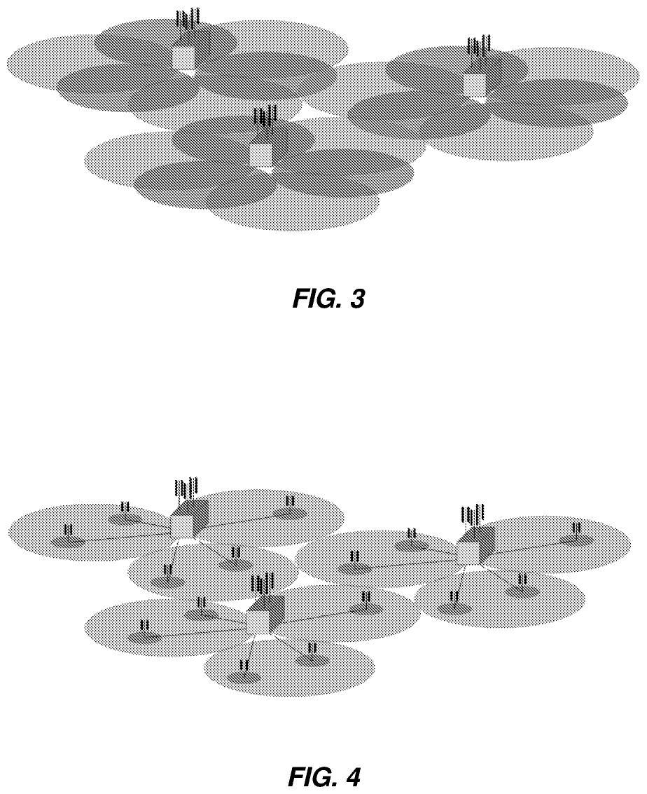

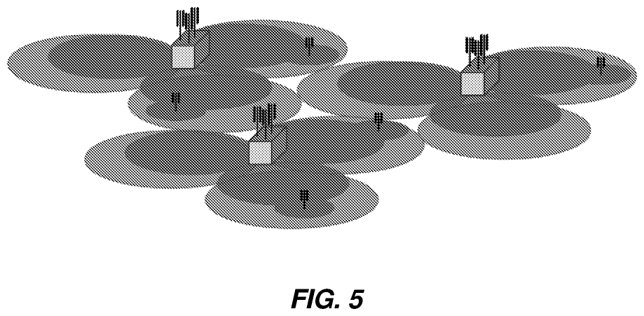

### DETAILED DESCRIPTION

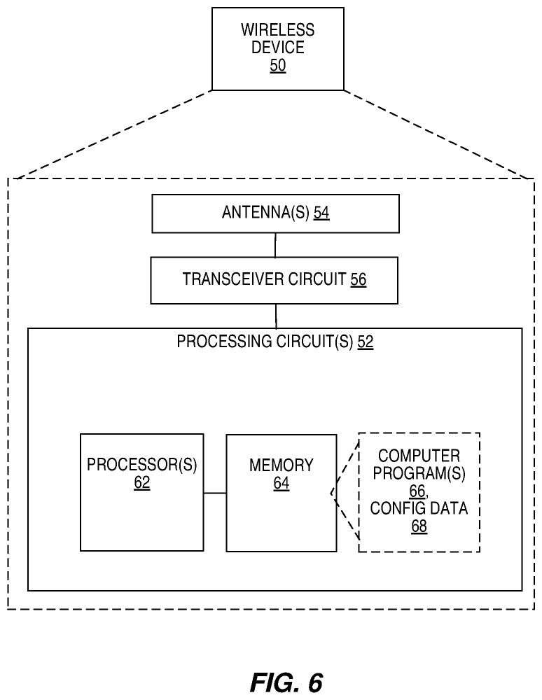

Embodiments of the present invention provide for the UE to assist the network with measurement information for faster multi-carrier establishment. FIG. 6 illustrates an example of such a UE, shown as wireless device 50. The wireless device 50 may represent any wireless device that may operate in a network and that is capable of communicating with a network node or another wireless device over radio signals. The wireless device 50 may also be referred to, in various contexts, as a radio communication device, a target device, a device-to-device (D2D) UE, a machine-type UE or UE capable of machine to machine (M2M) communication, a sensor-equipped UE, a PDA (personal digital assistant), a wireless tablet, a mobile terminal, a smart phone, laptop-embedded equipment (LEE), laptop-mounted equipment (LME), a wireless USB dongle, a Customer Premises Equipment (CPE), etc.

The wireless device 50 communicates with one or more radio nodes or base stations via antennas 54 and a transceiver circuit 56. The transceiver circuit 56 may include transmitter circuits, receiver circuits, and associated control circuits that are collectively configured to transmit and receive signals according to a radio access technology, for the purposes of providing cellular communication services.

The wireless device 50 also includes one or more processing circuits 52 that are operatively associated with and control the radio transceiver circuit 56. The processing circuitry 52 comprises one or more digital processors 62, e.g., one or more microprocessors, microcontrollers, Digital Signal Processors (DSPs), Field Programmable Gate Arrays (FPGAs), Complex Programmable Logic Devices (CPLDs), Application Specific Integrated Circuits (ASICs), or any mix thereof. More generally, the processing circuitry 52 may comprise fixed circuitry, or programmable circuitry that is specially adapted via the execution of program instructions implementing the functionality taught herein, or may comprise some mix of fixed and programmed circuitry. The processing circuitry 52 may be multi-core.

The processing circuitry 52 also includes a memory 64. The memory 64, in some embodiments, stores one or more computer programs 66 and, optionally, configuration data 68. The memory 64 provides non-transitory storage for the computer program 66 and it may comprise one or more types of computer-readable media, such as disk storage, solid-state memory storage, or any mix thereof. By way of non-limiting example, the memory 64 comprises any one or more of SRAM, DRAM, EEPROM, and FLASH memory, which may be in the processing circuitry 52 and/or separate from processing circuitry 52. In general, the memory 64 comprises one or more types of computer-readable storage media providing non-transitory storage of the computer program 66 and any configuration data 68 used by the wireless device 50. Here, “non-transitory” means permanent, semi-permanent, or at least temporarily persistent storage and encompasses both long-term storage in non-volatile memory and storage in working memory, e.g., for program execution.

The processing circuitry 52 of the wireless device 50 is configured to assist the network with establishing multi-carrier operation in a wireless communication network. The processing circuitry 52 is configured to perform measurements on one or more cells and/or beams and/or carriers, while in idle mode or in an inactive state. The processing circuitry 52 is also configured to determine information for assisting an establishment of multi-carrier operation, based on the measurements, and transmit the information to the wireless communication network.

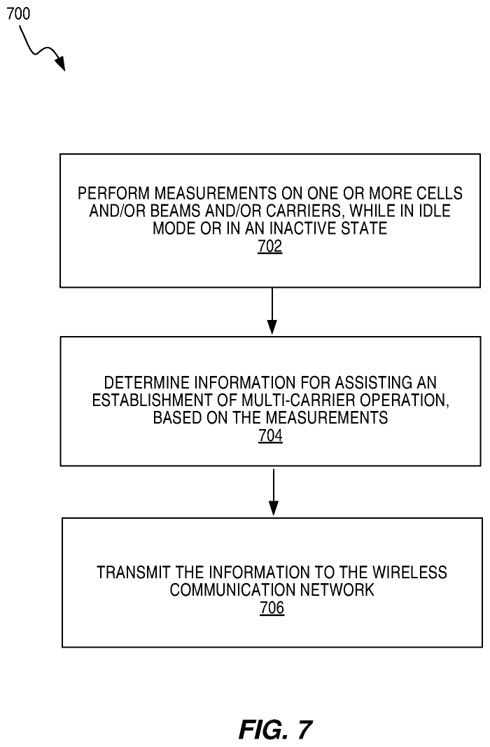

Regardless of the physical implementation, the processing circuitry 52 is configured to perform a method for assisting the network with establishing multi-carrier operation, such as the method 700, shown in FIG. 7, which includes performing measurements on one or more cells and/or beams and/or carriers, while in idle mode or in an inactive state (block 702) and determining information for assisting an establishment of multi-carrier operation, based on the measurements (block 704). The method 700 also includes transmitting the information to the wireless communication network (block 706). The information may include measured values for signal level and/or quality for one or more of the cells and/or beams and/or carriers. Determining the information may include conditionally including, in the information, measured values that meet one or more predetermined threshold conditions. It will be appreciated that this avoids the transmission of values for cells, beams, or carriers that are not suitable or that are less likely to be used for multi-carrier operation.

In some embodiments, the wireless device 50 may determine such measurements only upon certain conditions, in order to save battery power. For example, measurements on one or more cells and/or beams and/or carriers may be performed for a predetermined time beginning when the wireless device enters or receives an instruction to enter the idle mode or inactive state. Measurements may also be performed under certain conditions. These conditions may include: the wireless device is within coverage of one or more cells to which the wireless device was connected prior to the wireless device going idle or inactive; the wireless device is still camping on one or more cells to which the wireless device was connected to prior to the wireless device going idle or inactive; or signals of one or more cells by which the wireless device was served, prior to the wireless device going idle or inactive, have signal strength and/or quality levels that still meet a threshold. It will be appreciated that these conditions may prevent the wireless device from making unnecessary measurements or searching for cells or beams that are not likely to be nearby.

The method 700 may include receiving, from the wireless communication network while in connected or active mode, an indication of which cells and/or beams and/or carriers to measure while in idle mode or in an inactive state, and the measurements may be performed on the indicated cells and/or carriers. The measurements may be performed on cells and/or beams and/or carriers used in a previous multi-carrier operation.

In some cases, the transmitting of the information in connection establishment signaling is conditioned on a determination of whether one or more measurements meet a predetermined threshold condition. Again, this may avoid the transmission of unhelpful information. In other cases, the information in connection establishment signaling is transmitted only upon a determination that the wireless device has received an indication from the wireless communication network, that the wireless device is to transmit the information in the connection establishment signaling.

The information may be transmitted in connection establishment signaling to the wireless communication network. This may include transmission in a connection request message or a connection setup completion message.

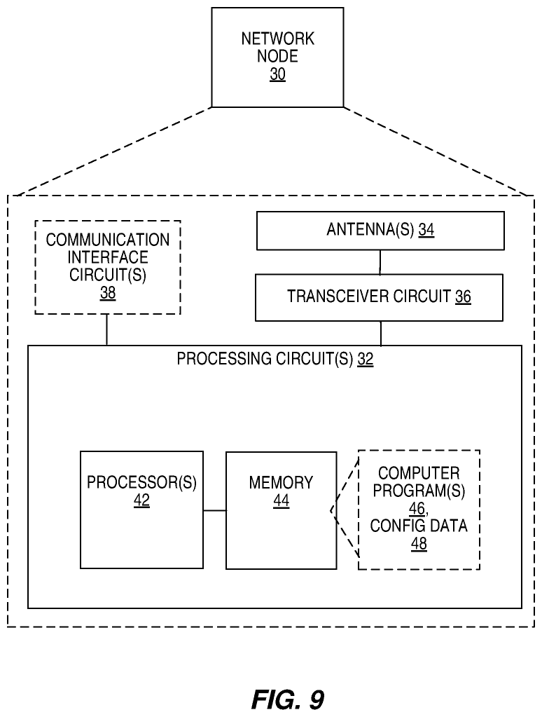

The techniques referred to above for the wireless device 50 can be used to assist one or more network nodes (e.g., base station, eNodeB or eNB) in establishing multi-carrier operation. Such a network node is represented by network node 30 illustrated in FIG. 9. The network node 30 facilitates communication between wireless devices and possibly the core network. The network node 30 comprises, for example, one or more radio network nodes that provide radio link connectivity between a wireless communication system and one or more wireless devices operating in the system. It is contemplated herein that network node determinations may be made in an individual node, performed cooperatively between two or more nodes, or performed in at least a partially distributed fashion. For example, certain aspects of processing may be implemented in a centralized node or even in a cloud-based network node.

The network node 30 communicates with wireless devices via antennas 34 and a transceiver circuitry 36. The transceiver circuitry 36 includes transmitter circuitry, receiver circuitry, and associated control circuits that are collectively configured to transmit and receive signals according to a radio access technology, for the purposes of providing communicatively coupling wireless devices to the wireless communication system. The example network node 30 may include communication interface circuitry 38 that includes circuitry for communicating with other nodes 30 and/or other types of nodes in the wireless communication system.

The network node 30 also include processing circuitry 32 that is operatively associated with the communication interface circuit 38 and transceiver circuitry 36. The processing circuitry 32 comprises one or more digital processors 42, e.g., one or more microprocessors, microcontrollers, DSPs, FPGAs, CPLDs, ASICs, or any mix thereof. More generally, the processing circuitry 32 may comprise fixed circuitry and/or programmable circuitry that is specially configured via the execution of program instructions to implement the functionality taught herein.

In at least some embodiments, the processing circuitry 32 includes or is associated with memory 44. The memory 44, in some embodiments, stores one or more computer programs 46 and, optionally, configuration data 48. The memory 44 provides non-transitory storage for the computer program 46 and it may comprise one or more types of computer-readable media, such as disk storage, solid-state memory storage, or any mix thereof. By way of non-limiting example, the memory 44 comprises any one or more of SRAM, DRAM, EEPROM, and FLASH memory, which may be in the processing circuitry 32 and/or separate from the processing circuitry 32. In general, the memory 44 comprises one or more types of computer-readable storage media providing non-transitory storage of the computer program 46 and any configuration data 48 used by the node(s) 30.

In some embodiments, the processor 42 of the processing circuitry 32 may execute a computer program 46 stored in the memory 44 that configures the processor 42 to assist a use information from the wireless device to establish multi-carrier operation. The processing circuitry 32 is configured to receive, from the wireless device, measurement information for one or more cells and/or beams and/or carriers. The processing circuitry 32 is also configured to select, based on the received measurement information, one or more cells and/or beams and/or carriers for multi-carrier operation with the wireless device. The processing circuitry 32 is further configured to establish multi-carrier operation for the wireless device using the selected cells and/or beams and/or carriers.

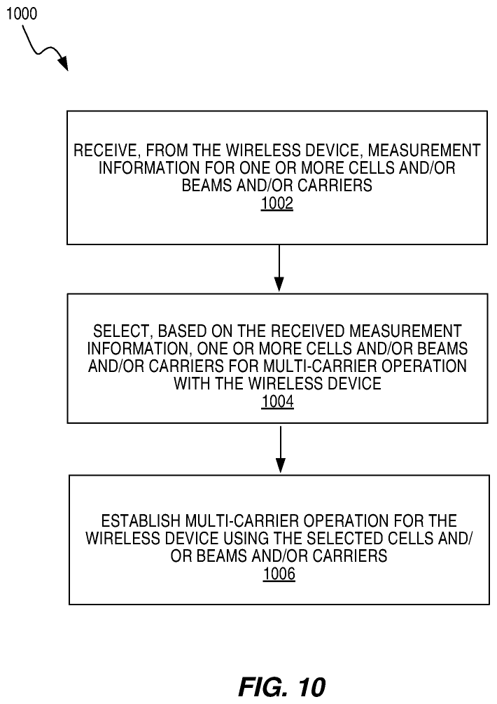

Regardless of its specific implementation, the processing circuitry 32 is configured to perform a method, such as the method 1000 illustrated in FIG. 10. The method 1000 includes receiving, from the wireless device, measurement information for one or more cells and/or beams and/or carriers (block 1002) and selecting, based on the received measurement information, one or more cells and/or beams and/or carriers for multi-carrier operation with the wireless device (block 1004). The method 1000 also includes establishing multi-carrier operation for the wireless device using the selected cells and/or beams and/or carriers (block 1006).

The method 1000 may include transmitting, to the wireless device prior to the receiving of the measurement information, an indication of which cells and/or beams and/or carriers to measure during idle state and/or during an inactive state, or measurements on cells and/or beams and/or carriers previously used for multi-carrier operation.

The method 1000 may include receiving the measurement information in connection establishment signaling to the wireless communication network. This may include in a connection request message or a connection setup completion message.

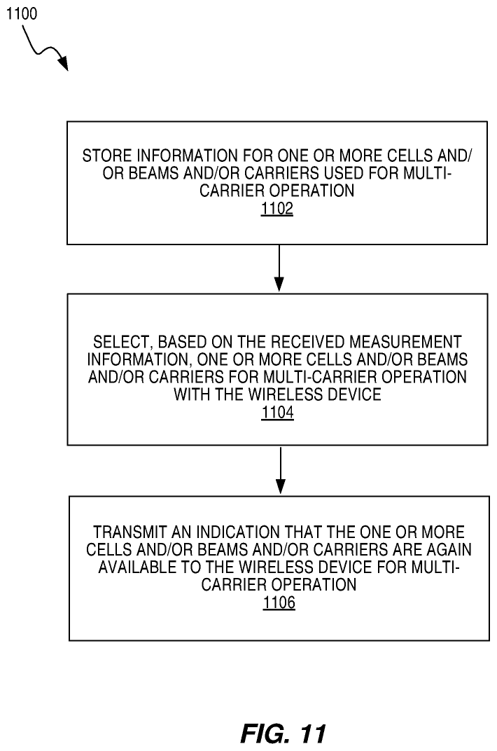

The wireless device 50 and network node 30 may also rely on information about previous multi-carrier operations. For example, the processing circuitry 52 of the wireless device 50 may be configured to perform another method 1100, as illustrated in FIG. 11. The method 1100 includes storing information for one or more cells and/or beams and/or carriers used for multi-carrier operation (block 1102) and determining, upon connection establishment after being in idle mode or in an inactive state, that the one or more cells and/or beams and/or carriers previously used for multi-carrier operation are available to the wireless device 50 (block 1104). The method 1100 may also include transmitting an indication that the one or more cells and/or beams and/or carriers are available to the wireless device 50 for multi-carrier operation (block 1106).

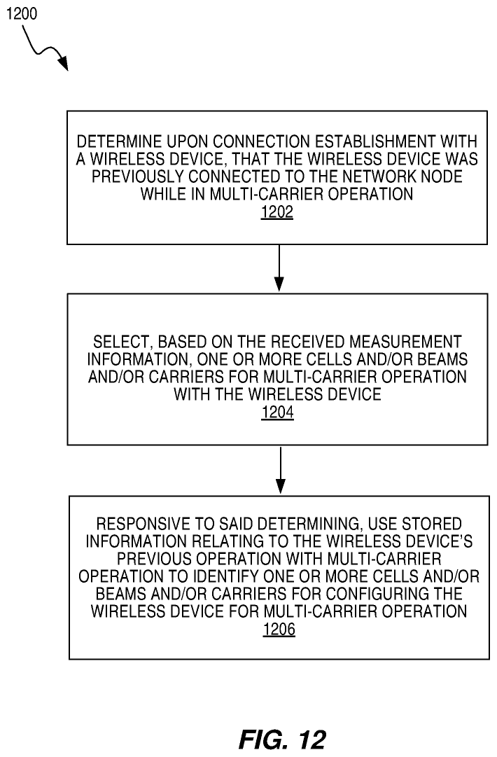

Similarly, the processing circuitry 32 of network node 30 may be configured to perform another method 1200, as illustrated in FIG. 12. The method 1200 includes determining upon connection establishment with a wireless device, that the wireless device was previously connected to the network node while in multi-carrier operation (block 1202) and, responsive to the determining, using stored information relating to the wireless device's previous operation with multi-carrier operation to identify one or more cells and/or beams and/or carriers for configuring the wireless device for multi-carrier operation (block 1204).

The method 1200 may include configuring the wireless device for multi-carrier operation using the identified one or more cells and/or beams and/or carriers. In some embodiments, this is responsive to receiving an indication from the wireless device that the identified one or more cells and/or beams and/or carriers are available to the wireless device for multi-carrier operation. While the wireless device performs measurements of cells when the UE is in, or transits from, an idle mode. However, it should be appreciated that, unless otherwise stated, the embodiments described herein can be used when the wireless device is in other states, for example, suspended state, dormant state, inactive state, etc.

Also, it should be appreciated that while the UE is measuring cells in one example, the UE may also measure frequencies, beams, carriers, reference signals, etc. When, in certain embodiments, the UE is to measure certain cells when in idle mode, this may be interpreted to mean that the UE will not measure other cells, at least for purposes of determining information to provide the network for multi-carrier establishment assistance.

The UE may perform certain types of measurements of a cell, beam or carrier (frequency). In fact, the UE may perform certain types of measurements for certain purposes. For example, the UE may perform one type of measurements for a group of cells for the purpose of adding and removing cells. However, the UE may perform other types of measurements of other cells for other purposes such as positioning, cell reselection, etc.

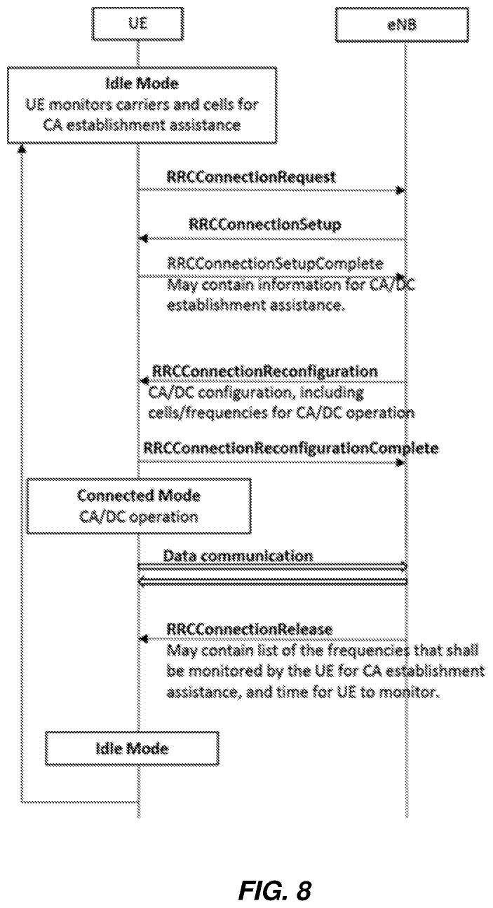

FIG. 8 illustrates a more detailed example of the principles described earlier for methods 700 and 1000, using 3GPP LTE radio resource control (RRC) signaling and messages in the context of CA or DC. While LTE will be used in this example, the methods could be applied to other radio access technologies (RATs) such as 3GPP NR.

In the example of FIG. 8, when the UE is in idle mode, it monitors carriers and cells for the purpose of CA/DC establishment assistance. Following a connection request message to the eNB and a connection setup message from the eNB, the UE sends information for CA/DC establishment assistance to the eNB. In some cases, the assistance information is sent in the connection request message.

The eNB then uses the information to establish a CA/DC configuration for the wireless device, including cells and frequencies for CA/DC operation. Therefore, when the UE enters connected mode, data communication can commence in CA/DC mode right away, without having to make the CA/DC determinations upon entering connected mode. This is advantageous in providing the higher data rate allowed by CA/DC operation much sooner.

Upon release of the connection, the eNB may also indicate to the UE, a list of frequencies or carriers to monitor. This monitoring may include measuring signal strength and quality of the signals from the indicated cells and frequencies or carriers. These measurements may be made for the best cells on the frequencies monitored by the UE. The indication from the eNB may include for how long the monitoring or measuring is to take place.

In existing network deployments, a UE may, for idle mode cell re-selection purpose, be executing measurements on other cells on other frequencies than the frequency of the camped cell. These other frequencies are typically communicated to the UE via system information (broadcast) messages. In one embodiment, the UE provides measurement information to the eNB for the frequencies that also are provided to the UE for idle mode cell re-selection purpose.

In another embodiment, the system information broadcast messages are extended to indicate frequencies that are specifically intended to be reported by the UE for multi-carrier establishment assistance purposes (and are not used for cell re-selection).

In some embodiments, the UE (after having been released from multi-carrier operation to idle mode) monitors the same carriers as used when previously in a multi-carrier operation. In other embodiments, the network node indicates specifically in a message to the UE (e.g., in the message that releases the UE to idle mode) which frequencies shall be monitored by the UE for multi-carrier establishment assistance.

When the UE provides information for multi-carrier establishment assistance in the connection establishment signaling, this information may be conditionally included by the UE. Such conditions may include if cell signal levels are above certain thresholds. The eNB may also communicate these thresholds to the UE with the frequencies to monitor.

The UE provisioning in this example could also be conditional on network information provided in broadcast signaling or dedicated signaling. The UE may consider both dedicated and broadcast signaling from the network when determining whether the UE shall send the indication to the network. In some embodiments, the UE may only send the indication if the UE both has received an indication in connected mode that the UE shall provide indications to the network, as well as that the network broadcasts an indication that the UE shall provide indications to the network. This is beneficial in a scenario when the UE may move around between different cells. For example, the UE may start in cell A. When connected to cell A, the network entity associated with cell A (e.g., an eNB serving cell A) indicates that the UE shall provide indications if the UE moves from idle mode to connected mode and the UE gets connected to cell A. But then the UE moves to a cell B and cell B may not support receiving such indications and hence it may be unwanted that the UE sends the indication to cell B. However, if this embodiment is applied and the UE considers both dedicated and broadcast signaling, the UE will only send indications to cells if requested or expected by the network node(s) associated with cell B.

There may be certain conditions for the UE in this example to monitor frequencies for multi-carrier establishment assistance. In one embodiment, the UE considers a time duration for monitoring frequencies for multi-carrier establishment assistance. The UE may start a timer when UE enters the idle mode (or receives a message that the UE shall enter the idle mode).

This has the main benefit of saving the battery of the UE by not monitoring other frequencies for a longer timer when the UE will likely not enter multi-carrier operation again. The rationale for this is that some traffic has a bursty pattern in the sense that the UE, for instance, downloads some data and then processes that data before downloading more data. This would be the case for certain video services, where a first part of the video is downloaded and it starts to be played out for a certain time before the next part of the video is downloaded. So, if the time duration is configured correctly, it may be possible that the UE will continue to measure between two subsequent connected times. However, if the video has ended, the UE can stop measuring after a certain time after the video has ended.

With an appropriate timer setting in the UE (configured by the network, specified in a specification, or determined by the UE itself), the UE will not monitor or measure other frequencies for multi-carrier establishment assistance when it is unlikely that UE again will enter multi-carrier operation. In some cases, the UE will continue to measure in idle mode if certain conditions are fulfilled or stop measuring when conditions are no longer fulfilled. One example condition is that the UE is in coverage of the cell that the UE was connected to prior to going to idle mode. For example, if the UE was served by cell A (which may be the primary cell of the UE) when the UE was in connected mode and then the UE moves to idle mode, the UE would then stop measurements if the UE no longer is in coverage of cell A.

Another example condition is that the UE is camping on the cell which the UE was connected to prior to going to idle mode. For example, if the UE was served by cell A, the UE may stop measuring if the UE no longer is camping on cell A. Another possibility is that cell A meets certain requirements, such as that the signal strength and/or the signal quality is above a certain threshold. The threshold may be configured by the eNB or specified in a specification.

If, based on the above, the UE has stopped measuring cells because conditions were no longer fulfilled, the UE may resume measuring if the conditions become fulfilled again. Whether the UE resumes measuring may be constrained on how long it has been since the UE stopped measuring. For example, the UE may only resume measuring if the UE stopped measuring a predetermined amount of time ago. Otherwise, the UE would not resume measuring.

Note that the UE is “served” by a cell when the UE is in connected mode. A cell which the UE is “served” by may be a cell which is configured for the UE, or that the UE is connected to, etc. In LTE terms, this would comprise both primary and secondary cells. It may also be a particular cell such as the UE's primary cell or primary secondary cell. Note that, in LTE, the term primary cell is used for a cell associated with the master cell group, while primary secondary cell is a term used for a cell associated with a secondary cell group. In a sense, these cells are both primary cells of their respective cell group.

In some cases, the UE may be configured with multiple cells before moving to idle mode, such as in the case of CA. In the case that the UE has multiple cells, the UE may consider a set of cells when determining whether or not the UE should stop measuring or determining whether the UE shall continue to measure. To illustrate this, consider a scenario where the UE was configured with cell A, B and C prior to entering IDLE mode. The UE stops measuring whenever the UE is out of coverage of all of cells A, B and C, or when the UE is not camping on any of cells A, B or C, or when all these cells have a signal strength/quality which is below a threshold.

In another example, the UE stops measuring when any of the multiple cells meets the conditions or when the UE moves out of coverage of any of cells A, B or C. The UE may only consider certain (of the multiple) cells when doing the above evaluation. For example, the UE may only consider the primary cell and primary secondary cell.

Note that, in general, what has been described above with state transition between idle and connected mode is also applicable to state transitions between other similar transitions “inactive” or “suspended” and connected mode. In some cases, the UE behaves differently for different states. For instance, the UE may perform measurements for CA/DC establishment assistance in a suspended/inactive state, but if the UE moves to an idle state, the UE does not perform these measurements.

### ADDITIONAL IMPLEMENTATIONS

In some cases, the eNB remembers the UE and its past multi-carrier operations and/or measurements. For example, the eNB may store some context information related to the CA/DC operation for the UE when releasing the UE to idle mode. This context information may, for example, include information identifying the cells/frequencies used by the UE for CA/DC operation when the UE was released to idle. The eNB could use this information to assist when selecting cells and carriers for CA/DC for this UE, in case the UE, soon after being released, requests establishment of a connection again. This context information stored by the eNB is identified by an identifier associated with the UE. The identifier may be the S-TMSI (SAE-Temporary Mobile Subscriber Identity) indicated by the UE in the RRC CONNECTION REQUEST message. The eNB may consider this knowledge when determining which cells to configure for the UE for CA/DC operation, typically when the UE accesses the same cell as last time when UE was in CA/DC operation.

The eNB may discard information a certain time T after the UE has been released, or if the UE accesses a different cell. This has the benefit of clearing eNB memory if the UE has moved away from the coverage of the eNB and the UE will most likely not come back to the same cell.

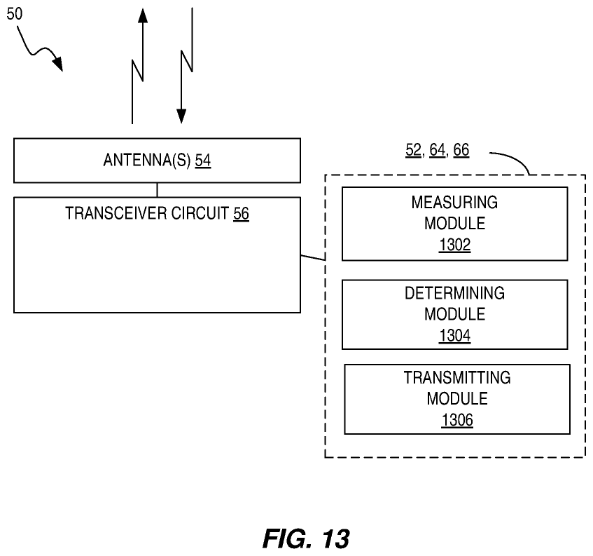

It will be appreciated that the processing circuitry 32, 52, as adapted with program code stored in program and data memory 44, 64, can implement any one or more of the wireless-device-related or network node-related methods described above using an arrangement of functional “modules,” where the modules are computer programs or portions of computer programs executing on the processor circuitry 32, 52. For example, FIG. 13 illustrates an example functional module or circuit architecture as may be implemented in the wireless device 50, e.g., based on the processing circuitry 52. The implementation includes a measuring module 1302 for performing measurements on one or more cells and/or beams and/or carriers, while in idle mode or in an inactive state. The implementation also includes a determining module 1304 for determining information for assisting an establishment of multi-carrier operation, based on the measurements and a transmitting module 1306 for transmitting the information to the wireless communication network.

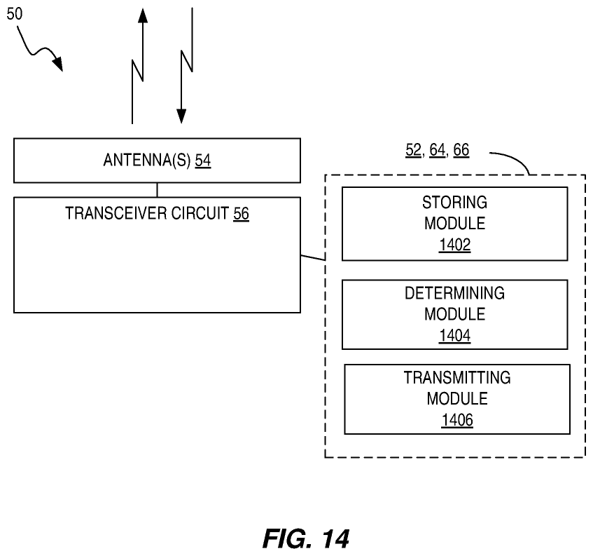

FIG. 14 illustrates another functional implementation of an architecture in a wireless device configured for multi-carrier operation in a wireless communication network. The implementation includes a storing module 1402 for storing information for one or more cells and/or beams and/or carriers used for multi-carrier operation and a determining module 1404 for determining, upon connection establishment after being in idle mode or in an inactive state, that the one or more cells and/or beams and/or carriers previously used for multi-carrier operation are available to the wireless device. The implementation also includes a transmitting module 1406 for transmitting an indication that the one or more cells and/or beams and/or carriers are again available to the wireless device for multi-carrier operation.

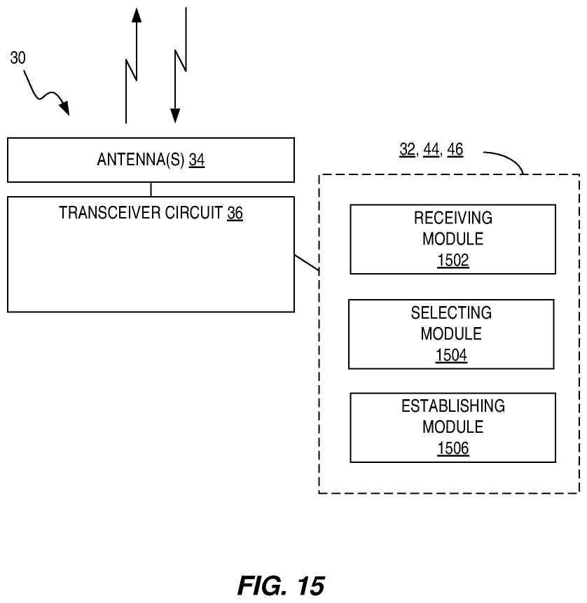

FIG. 15 illustrates an example functional module or circuit architecture for assisting a wireless device with multi-carrier operation as may be implemented in the network node 30, e.g., based on the processing circuitry 32. The implementation includes a receiving module 1502 for receiving, from the wireless device, measurement information for one or more cells and/or beams and/or carriers. The implementation also includes a selecting module 1504 for selecting, based on the received measurement information, one or more cells and/or beams and/or carriers for multi-carrier operation with the wireless device. The implementation further includes an establishing module 1506 for establishing multi-carrier operation for the wireless device using the selected cells and/or beams and/or carriers.

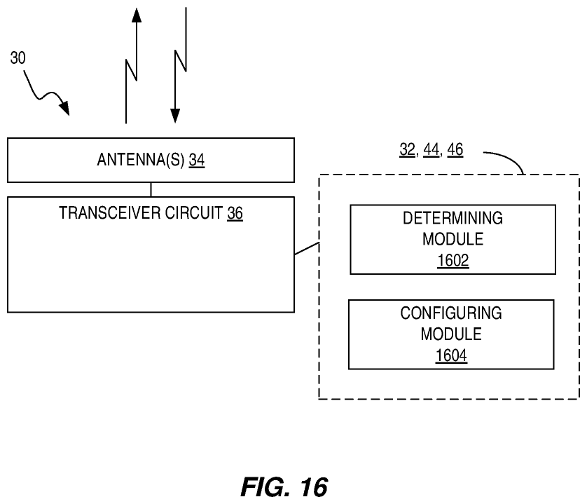

FIG. 16 illustrates another functional implementation of an architecture in a network node for assisting a wireless device with multi-carrier operation. The implementation includes a determining module 1602 for determining upon connection establishment with a wireless device, that the wireless device was previously connected to the network node while in multi-carrier operation. The implementation also includes, responsive to the determining, a configuring module 1604 for using stored information relating to the wireless device's previous operation with multi-carrier operation to identify one or more cells and/or beams and/or carriers for configuring the wireless device for multi-carrier operation.

### EXAMPLE EMBODIMENTS

In view of the detailed discussion and examples provided above, it will be appreciated that example embodiments of the presently disclosed techniques and apparatus include, but are not limited to, the following enumerated examples:
a). A wireless device configured for multi-carrier operation in a wireless communication network, the wireless device comprising:
   transceiver circuitry configured for multi-carrier communication; and
   processing circuitry operatively associated with the transceiver circuitry and configured to:
      perform measurements on one or more cells and/or beams and/or carriers, while in idle mode or in an inactive state;
      determine information for assisting an establishment of multi-carrier operation, based on the measurements; and transmit the information to the wireless communication network.
b). The wireless device of embodiment a), wherein the information comprises measured values for signal level and/or quality for one or more of the cells and/or beams and/or carriers.
c). The wireless device of embodiment b), wherein the processing circuitry is configured to determine the information by conditionally including, in the information, measured values that meet one or more predetermined threshold conditions.
d). The wireless device of any of embodiments a)-c), wherein performing measurements on one or more cells and/or beams and/or carriers comprises performing the measurements for a predetermined time beginning when the wireless device enters or receives an instruction to enter the idle mode or inactive state.
e). The wireless device of any of embodiments a)-c), wherein the processing circuitry is configured to perform measurements on one or more cells and/or beams and/or carriers by continuing to perform the measurements only under certain conditions, wherein the certain conditions comprise one or more of:
   the wireless device is within coverage of one or more cells to which the wireless device was connected prior to the wireless device going idle or inactive;
   the wireless device is still camping on one or more cells to which the wireless device was connected to prior to the wireless device going idle or inactive; and
   signals of one or more cells by which the wireless device was served, prior to the wireless device going idle or inactive, have signal strength and/or quality levels that still meet a threshold.
f). The wireless device of any of embodiments a)-e), wherein the processing circuitry is configured to receive, from the wireless communication network while in connected or active mode, an indication of which cells and/or beams and/or carriers to measure while in idle mode or in an inactive state, and perform the measurements on the indicated cells and/or carriers.
g). The wireless device of any of embodiments a)-f), wherein the processing circuitry is configured to perform measurements on one or more cells and/or beams and/or carriers by performing the measurements on cells and/or beams and/or carriers used in a previous multi-carrier operation.
h). The wireless device of any of embodiments a)-g), wherein the processing circuitry is configured to transmit the information in connection establishment signaling conditioned on a determination of whether one or more measurements meet a predetermined threshold condition.
i). The wireless device of any of embodiments a)-h), wherein the processing circuitry is configured to transmit the information in the connection establishment signaling only upon a determination that the wireless device has received an indication from the wireless communication network, that the wireless device is to transmit the information in the connection establishment signaling.
j). The wireless device of any of embodiments a)-i), wherein the processing circuitry is configured to transmit the information in connection establishment signaling to the wireless communication network.
k). The wireless device of embodiment j), wherein the processing circuitry is configured to transmit the information in a connection request message.
l). The wireless device of embodiments j), wherein the processing circuitry is configured to transmit the information in a connection setup completion message.
m). A network node configured to assist a wireless device with multi-carrier operation in a wireless communication network, the network node comprising:
   transceiver circuitry configured for communicating with the wireless device in multi-carrier operation; and
   processing circuitry operatively associated with the transceiver circuitry and configured to:
      receive, from the wireless device, measurement information for one or more cells and/or beams and/or carriers, the measurement information relating to measurements performed by the wireless device while in idle mode or in an inactive state;
      select, based on the received measurement information, one or more cells and/or beams and/or carriers for multi-carrier operation with the wireless device; and
      establish multi-carrier operation for the wireless device using the selected cells and/or beams and/or carriers.
n). The network node of embodiment m), wherein the processing circuitry is configured to transmit, to the wireless device prior to the receiving of the measurement information, an indication of which cells and/or beams and/or carriers to measure during idle state and/or during an inactive state.
o). The network node of embodiment m), wherein the processing circuitry is configured to transmit, to the wireless device prior to the receiving of the measurement information, an indication to perform, during idle state and/or during an inactive state, measurements on cells and/or beams and/or carriers previously used for multi-carrier operation.
p). The network node of any of embodiments m)-o), wherein the processing circuitry is configured to receive the measurement information by receiving measured values for signal level and/or quality for one or more of the cells and/or beams and/or carriers.
q). The network node of any of embodiments m)-o), wherein the processing circuitry is configured to receive the measurement information by receiving the measurement information in connection establishment signaling to the wireless communication network.
r). The network node of embodiment q), wherein the processing circuitry is configured to receive the measurement information in a connection request message.
s). The network node of embodiment q), wherein the processing circuitry is configured to receive the measurement information in a connection setup completion message.
t). A wireless device configured for multi-carrier operation in a wireless communication network, the wireless device comprising:
   transceiver circuitry configured for multi-carrier communication; and
   processing circuitry operatively associated with the transceiver circuitry and configured to:
      store information for one or more cells and/or beams and/or carriers used for multi-carrier operation;
      determine, upon connection establishment after being in idle mode or in an inactive state, that the one or more cells and/or beams and/or carriers previously used for multi-carrier operation are available to the wireless device; and
      transmit an indication that the one or more cells and/or beams and/or carriers are again available to the wireless device for multi-carrier operation.
u). A network node configured to support multi-carrier operation in a wireless communication network, the network node comprising:
   transceiver circuitry configured for communicating with the wireless device in multi-carrier operation; and
   processing circuitry operatively associated with the transceiver circuitry and configured to:
      determine upon connection establishment with a wireless device, that the wireless device was previously connected to the network node while in multi-carrier operation; and,
      responsive to the determining, use stored information relating to the wireless device's previous operation with multi-carrier operation to identify one or more cells and/or beams and/or carriers for configuring the wireless device for multi-carrier operation.
v). The network node of embodiment u), wherein the processing circuitry is configured to configure the wireless device for multi-carrier operation using the identified one or more cells and/or beams and/or carriers.
w). The network node of embodiment u), wherein the processing circuitry is configured to configure the wireless device responsive to receiving an indication from the wireless device that the identified one or more cells and/or beams and/or carriers are again available to the wireless device for multi-carrier operation.
x). A wireless device configured for multi-carrier operation in a wireless communication network, comprising:
   a performing module for performing measurements on one or more cells and/or beams and/or carriers, while in idle mode or in an inactive state;
   a determining module for determining information for assisting an establishment of multi-carrier operation, based on the measurements; and
   a transmitting module for transmitting the information to the wireless communication network.
y). A network node configured to assist a wireless device with multi-carrier operation in a wireless communication network, comprising:
   a receiving module for receiving, from the wireless device, measurement information for one or more cells and/or beams and/or carriers;
   a selecting module for selecting, based on the received measurement information, one or more cells and/or beams and/or carriers for multi-carrier operation with the wireless device; and
   an establishing module for establishing multi-carrier operation for the wireless device using the selected cells and/or beams and/or carriers.
z). A wireless device configured for multi-carrier operation in a wireless communication network, comprising:
   a storing module for storing information for one or more cells and/or beams and/or carriers used for multi-carrier operation;
   a determining module for determining, upon connection establishment after being in idle mode or in an inactive state, that the one or more cells and/or beams and/or carriers previously used for multi-carrier operation are available to the wireless device; and
   a transmitting module for transmitting an indication that the one or more cells and/or beams and/or carriers are again available to the wireless device for multi-carrier operation.
zz). A network node configured to support multi-carrier operation in a wireless communication network, comprising:
   a determining module for determining upon connection establishment with a wireless device, that the wireless device was previously connected to the network node while in multi-carrier operation; and,
   a configuring module for, responsive to the determining, using stored information relating to the wireless device's previous operation with multi-carrier operation to identify one or more cells and/or beams and/or carriers for configuring the wireless device for multi-carrier operation.

It will be appreciated by the person of skill in the art that various modifications may be made to the above-described embodiments without departing from the scope of the present invention. For example, although embodiments of the present invention have been described with examples that reference a communication system compliant to the 3GPP-specified LTE or NR standards, it should be noted that the solutions presented may be equally well applicable to other networks, depending on their design and capability.

1-37. (canceled)

38. A method in a wireless device configured for multi-carrier operation in a wireless communication network, the method comprising:
performing measurements on one or more cells and/or beams and/or carriers, while in idle mode or in an inactive state;
determining information for assisting an establishment of multi-carrier operation, based on the measurements; and
transmitting the information to the wireless communication network.

39. The method of claim 38, wherein the information comprises measured values for signal level and/or quality for one or more of the cells and/or beams and/or carriers.

40. The method of claim 39, wherein determining the information comprises conditionally including, in the information, measured values that meet one or more predetermined threshold conditions.

41. The method of claim 38, wherein performing measurements on one or more cells and/or beams and/or carriers comprises performing the measurements for a predetermined time beginning when the wireless device enters or receives an instruction to enter the idle mode or inactive state.

42. The method of claim 38, wherein performing measurements on one or more cells and/or beams and/or carriers comprises continuing to perform the measurements only under certain conditions, wherein the certain conditions comprise one or more of:
the wireless device is within coverage of one or more cells to which the wireless device was connected prior to the wireless device going idle or inactive;
the wireless device is still camping on one or more cells to which the wireless device was connected to prior to the wireless device going idle or inactive; and
signals of one or more cells by which the wireless device was served, prior to the wireless device going idle or inactive, have signal strength and/or quality levels that still meet a threshold.

43. The method of claim 38, further comprising receiving, from the wireless communication network while in connected or active mode, an indication of which cells and/or beams and/or carriers to measure while in idle mode or in an inactive state, and wherein performing measurements on one or more cells and/or beams and/or carriers comprises performing the measurements on the indicated cells and/or carriers.

44. The method of claim 38, wherein performing measurements on one or more cells and/or beams and/or carriers comprises performing the measurements on cells and/or beams and/or carriers used in a previous multi-carrier operation.

45. The method of claim 38, wherein the transmitting of the information in connection establishment signaling is conditioned on a determination of whether one or more measurements meet a predetermined threshold condition.

46. The method of claim 38, wherein the transmitting of the information comprises transmitting the information in connection establishment signaling upon a determination that the wireless device has received an indication from the wireless communication network that the wireless device is to transmit the information in the connection establishment signaling.

47. The method of claim 38, wherein transmitting the information comprises transmitting the information in connection establishment signaling to the wireless communication network.

48. The method of claim 47, wherein transmitting the information in the connection establishment signaling comprises transmitting the information in a connection request message or in a connection setup completion message.

49. A method in a network node configured to assist a wireless device with multi-carrier operation in a wireless communication network, the method comprising:
receiving, from the wireless device, measurement information for one or more cells and/or beams and/or carriers, the measurement information relating to measurements performed by the wireless device while in idle mode or in an inactive state;
selecting, based on the received measurement information, one or more cells and/or beams and/or carriers for multi-carrier operation with the wireless device; and
establishing multi-carrier operation for the wireless device using the selected cells and/or beams and/or carriers.

50. The method of claim 49, further comprising transmitting, to the wireless device prior to the receiving of the measurement information, an indication of which cells and/or beams and/or carriers to measure during idle state and/or during an inactive state.

51. The method of claim 49, further comprising transmitting, to the wireless device prior to the receiving of the measurement information, an indication to perform, during idle state and/or during an inactive state, measurements on cells and/or beams and/or carriers previously used for multi-carrier operation.

52. The method of claim 49, wherein receiving the measurement information comprises receiving measured values for signal level and/or quality for one or more of the cells and/or beams and/or carriers.

53. The method of claim 49, wherein receiving the measurement information comprises receiving the measurement information in connection establishment signaling to the wireless communication network.

54. The method of claim 53, wherein receiving the measurement information in the connection establishment signaling comprises receiving the measurement information in a connection request message or in a connection setup completion message.

55. A wireless device configured for multi-carrier operation in a wireless communication network, wherein the wireless device comprises:
a transceiver circuit configured to communicate with the wireless communication network; and
one or more processing circuits operatively coupled to the transceiver circuit and configured to use the transceiver circuit to:
perform measurements on one or more cells and/or beams and/or carriers, while in idle mode or in an inactive state;
determine information for assisting an establishment of multi-carrier operation, based on the measurements; and
transmit the information to the wireless communication network.

56. A network node configured to assist a wireless device with multi-carrier operation in a wireless communication network, wherein the network node comprises:
a transceiver circuit configured to communicate with the wireless device; and
one or more processing circuits operatively coupled to the transceiver circuit and configured to use the transceiver circuit to:
receive, from the wireless device, measurement information for one or more cells and/or beams and/or carriers, the measurement information relating to measurements performed by the wireless device while in idle mode or in an inactive state;
select, based on the received measurement information, one or more cells and/or beams and/or carriers for multi-carrier operation with the wireless device; and
establish multi-carrier operation for the wireless device using the selected cells and/or beams and/or carriers.
